(19) United States
(12) Patent Application Publication
(10) Pub. No.: US 2025/0041825 A1
(43) Pub. Date: Feb. 6, 2025

(54) Functionalized Covalent Organic Frameworks for Capturing Carbon Dioxide from Air and Flue Gas

(71) Applicant: The Regents of the University of California, Oakland, CA (US)

(72) Inventors: Omar M. Yaghi, Berkeley, CA (US); Hao Lyu, Berkeley, CA (US)

(21) Appl. No.: 18/905,490

(22) Filed: Oct. 3, 2024

Related U.S. Application Data
(63) Continuation of application No. PCT/US2023/064682, filed on Mar. 20, 2023.
(60) Provisional application No. 63/329,369, filed on Apr. 8, 2022.

(51) Int. Cl. B01J 20/22; B01D 53/62; B01D 53/81; B01J 20/28; C07F 15/02

(52) U.S. Cl. CPC B01J 20/226; B01D 53/62; B01D 53/81; B01J 20/28016; C07F 15/025; B01D 2253/202; B01D 2257/504; B01D 2257/80; B01D 2258/0283; B01D 2258/06

(57) ABSTRACT

Chemically and thermally stable covalent organic framework (COF) materials are configured and operative as solid adsorbents for capturing carbon dioxide, and optionally water, from air or post-combustion exhaust gas mixtures.

This invention was made with government support under the Department of Energy, grant number DE-FE0031956. The government has certain rights in the invention.

### INTRODUCTION

Capturing carbon dioxide (CO₂) from the air and flue gas is of vital importance to mitigate the environmental problems brought by the vast amount of anthropogenic CO₂ emission. The overarching challenge of this process, whether from flue gas (such as post-combustion capture, PCC) or the air (direct air capture, DAC), lies in the minimization of cost per unit capture of CO₂. This requires the combined optimization of multiple factors at the same time. Despite multiple materials have been developed in laboratories or deployed in the carbon capture industry, it remains unresolved to achieve optimal performances in all aspects including (a) high selectivity per cycle of adsorption of CO₂ from a dilute source, (b) selectivity and robustness of CO₂ capture in the presence of water, oxygen, and other impurities in the gas mixture, (c) low energy consumption to regenerate the sorbent, (d) long-term stability of the sorbent's performance, and (e) facile synthesis and handling of the materials.

Covalent organic frameworks (COFs) are a class of porous, crystalline organic solid materials that are composed of organic building units connected with covalent bonds, extending in two- or three-dimensional spaces. Our prior inventions include B20-005; WO2021142474; PCT/US21/13010, entitled “Covalent Organic Frameworks”, with priority claim to B20-134-1, Ser. 63/023,107, entitled “Robust Covalent Organic Frameworks for Capturing CO₂ and H₂O from Air and Flue Gas”. Here we disclose novel, functionalized COFs exhibiting exceptional performances in carbon capture as solid adsorbents.

### SUMMARY OF THE INVENTION

The invention provides compositions comprising one or more chemically and thermally stable covalent organic framework (COF) materials configured and operative as solid adsorbents for capturing carbon dioxide, and optionally water, from gases like air or a post-combustion exhaust gas mixtures, and methods of use.

The invention provides the functionalization of covalent organic frameworks and the use in capturing carbon dioxide from the air or flue gas thereof, and in a specific example, COF-609, for use in direct air capture. By introducing amine functional groups onto the backbone of the framework, the obtained structure is capable of adsorbing CO₂ from low concentration in the presence of water and oxygen. Furthermore, regeneration of the material benefits from mild heat requirement and low uptake of water, which further reduces the energy consumption and consequently reducing the cost per unit CO₂ capture. This class of sorbents enables a high level of systematic optimization of performance in CO₂ capture, while maintaining sufficient scalability toward bench and pilot scales, and practical scales.

The invention provides a class of solid adsorbent for carbon dioxide capture based on the structure and chemistry of covalent organic frameworks (COFs). Through functionalization of the COFs, these sorbents bear reactive functional groups that are capable of capturing carbon dioxide from gas mixtures such as air, methane flue gas, and coal flue gas, with high uptake capacity with or without the presence of humidity. Tuning of the reactive functionalities allows for mild temperature and/or vacuum regeneration, and the hydrophobicity minimizes the energy consumption as a result of water desorption during regeneration. The chemical and thermal stability of such frameworks also enable the long-term stability of cycling adsorption-regeneration processes, where an overall cost reduction can be achieved in both direct air capture and post-combustion capture of carbon dioxide. In embodiments the covalent organic framework adsorbents are configured as a solid adsorbent or components in sorbent composites in carbon capturing processes for direct air capture, post-combustion capture, and for other scenarios, such as carbon dioxide removal from natural gas.

In an aspect, the invention provides a composition comprising a chemically and thermally stable covalent organic framework (COF) material configured and operative as a solid adsorbent for capturing carbon dioxide from air or a post-combustion exhaust gas mixture, and comprising organic building blocks defined in FIG. 1, in which the substituents are defined in FIG. 2, with side chains defined in the same fashions in FIGS. 1 and 2, linked by the linkages defined in FIG. 4, and all possible topologies (the layered topologies of sql, hcb, hxl, kgm, bex, kgd, tth, fxt or mtf and 3D topologies of dia, lon, pcu, srs, pto, pts, tbo, bor, cnt, rra, ffc, pto, fjh, or dia-w are examples of such topologies), such as shown in FIG. 5.

Excluded are COFs and linkages that are not chemically or thermally stable in conditions for CO₂ capture from air or a post-combustion exhaust gas mixture. Hence, our invention is limited to the confined range of COFs as defined in our claims, including being characterized as (1) chemically and thermally stable, as confirmed by characterization, and (2) operative and configured for CO₂ capture from air and post-combustion exhaust gas mixture.

In embodiments:
the composition is contained in a matrix configured as a sorption bed, fluidized bed, coated heat exchanger, or membrane, optionally, in a fluid flow path configured to pass the air or mixture over, around and/or through the matrix;
the composition comprises the air or post-combustion exhaust gas mixture, wherein water is present in the air or mixture, and the material is configured and is operative to harvest the water from the air or mixture, and provides facile collection of water as a second value-delivering function, wherein in this embodiment, the harvesting of water is a potential byproduct when water is present in the gas mixture
the COF has a structure disclosed herein; and/or
   the COF is COF-609, which is composed of 2,4,6-tris(4-formylphenyl)-1,3,5-triazine and 4,4′-diaminobenzanilide linked through tetrahydroquinoline (THQ) linkage to form an all-covalent backbone with hcb topology, while the side chains from the THQ linkage bears primary, secondary, and tertiary amines that are used as the chemisorbent or part of the sorbent for CO₂ capture.

In an aspect the invention provides a system for capturing carbon dioxide from air or a post-combustion exhaust gas mixture comprising a matrix, such as a sorption bed containing a subject composition configured as a solid adsorbent for capturing the carbon dioxide, and optionally water, from the air or mixture.

In an aspect, the invention provides a method comprising using a subject composition as a solid adsorbent for capturing carbon dioxide, and optionally water, from air or a post-combustion exhaust gas mixture.

The invention encompasses all combinations of the particular embodiments recited herein, as if each combination had been laboriously recited.

### BRIEF DESCRIPTION OF THE DRAWINGS

FIG. 1. Schematic representation of organic building blocks.

FIG. 2A-B. Schematic representation of organic fragments comprising organic building units in the range of definition in this disclosure.

FIG. 3. Example structures of organic building units.

FIG. 4. Schematic representation of linkages in the range of definition of COFs in this disclosure.

FIG. 5. Schematic representations of common examples of topologies in COFs, i.e. sql, hcb, hxl, kgm, kgd, bex, tth, mtf, srs, dia, lon, bor, ctn, pts, tbo, pto, pcu.

FIG. 6. Schematic representation of an example breakthrough system required for the embodiment of this disclosure.

FIG. 7. Schematic representation of COF-609.

FIG. 8. Fourier Transform Infrared Spectra of the three stages of synthesis, including COF-609-Im, COF-609-THQ/Im, and COF-609.

FIG. 9. Solid state nuclear magnetic resonance spectra (¹³C) of the three stages of synthesis, including COF-609-Im, COF-609-THQ/Im, and COF-609.

FIG. 10. Thermogravimetric analysis trace of COF-609 under N₂.

FIG. 11. CO₂ sorption isotherms for COF-609-Im, COF-609-THQ/Im, and COF-609 at 25° C.

FIG. 12. Dynamic CO₂ adsorption breakthrough measurement result for COF-609.

FIG. 13. H₂O vapor sorption isotherm for COF-609 at 25° C.

### DESCRIPTION OF PARTICULAR EMBODIMENTS OF THE INVENTION

Unless contraindicated or noted otherwise, in these descriptions and throughout this specification, the terms “a” and “an” mean one or more, the term “or” means and/or. It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein, including citations therein, are hereby incorporated by reference in their entirety for all purposes.

The invention provides a generalized enabling methodology to achieve and tune CO₂ capture performance using chemically and thermally stable covalent organic framework materials (COFs) as solid adsorbent for capturing carbon dioxide from air and post-combustion exhaust gas mixture. The physical and chemical properties of such adsorbents allow for the achievement of high capacity, low energy penalty, and long-term cyclability, with or without moisture and gaseous impurities. In some variations where water is present in the feed gas mixture, the adsorbents are capable of providing harvesting of water from the gas mixture parallel to the process of CO₂ capture, such that the system provides facile collection of water as a second value-deliverable function.

The robust covalent organic frameworks are useful as an active and efficient solid adsorbent in carbon capturing processes for direct air capture, post-combustion capture, and for other scenarios, such as CO₂ removal from natural gas. Prototypical covalent organic frameworks are described in: (1) Zhang, B.; Wei, M.; Mao, H.; Pei, X.; Alshmimri, S. A.; Reimer, J. A.; Yaghi, O. M. Crystalline Dioxin-Linked Covalent Organic Frameworks from Irreversible Reactions. J. Am. Chem. Soc., 2018, 140, 12715-12719; (2) Lyu, H.; Diercks, C. S.; Zhu, C.; Yaghi, O. M. Porous Crystalline Olefin-Linked Covalent Organic Frameworks. J. Am. Chem. Soc. 2019, 141, 6848-6852; and tetrahydroquinoline COF-609 as is provided in this invention as an example

### Designated Covalent Organic Frameworks

The subject covalent organic frameworks comprise organic building units joined together through linkages into 2D or 3D extended structures, and include including directly synthesized and post-synthetically modified materials. The infinite extension of the linking of variable building units and linkages are defined mathematically by the topologies. All COFs disclosed in this invention are defined as follows, and not limited to the range of explicit description.

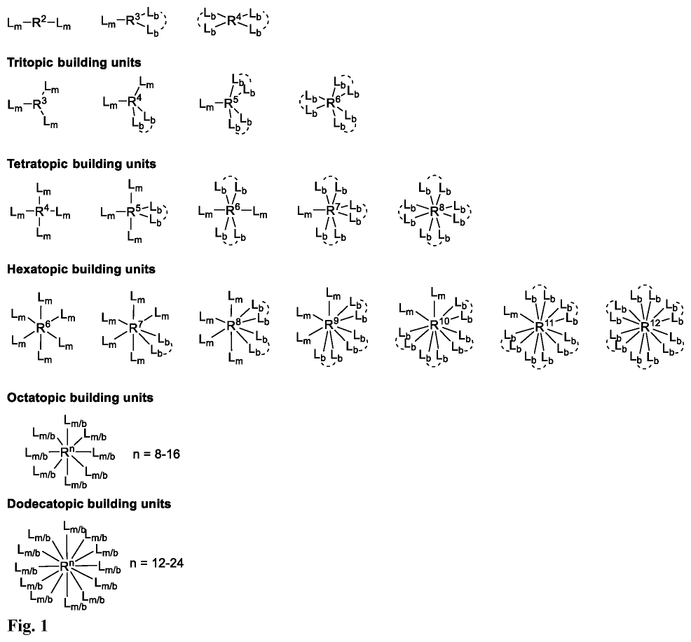

The organic building units are defined, but not limited to, the categories by the number of points of extension in FIG. 1. In the range of definition of this invention, each instance of organic building units comprises of an organic fragment R^{m} and m points of extension Lₘ or L_{b}. The superscript m in R^{m} describes that fragment R^{m} possesses m points of extension.

The points of extensions are defined as the covalent bonding between the two atoms in the immediate neighbor of the point of extension. In most variations, such atoms are one in the organic building unit and one in the linkage. In some other variations, the fragment (R²) contains no atoms, and two atoms are both from the linkage. In some other variations, the linkage contains no atoms, and two atoms are both from the organic building units. The points of extensions are either monodentate connections (1 point of extension connects to 1 linkage through 1 covalent bond, labeled as Lₘ) or as bidentate connections (2 points of extension pair up to connect to 1 linkage through 2 covalent bonds in total, each labeled as L_{b}).

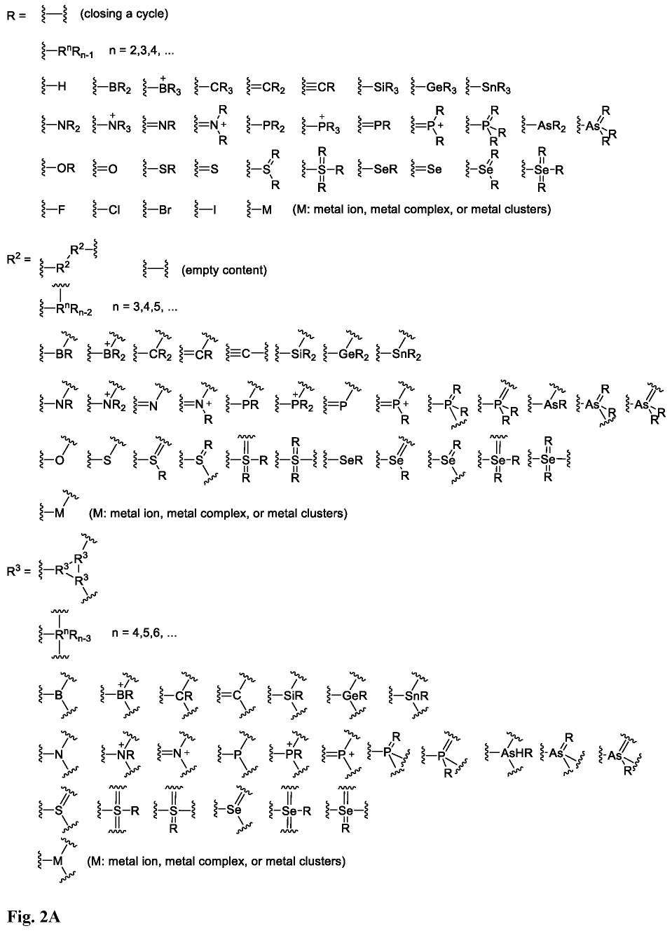

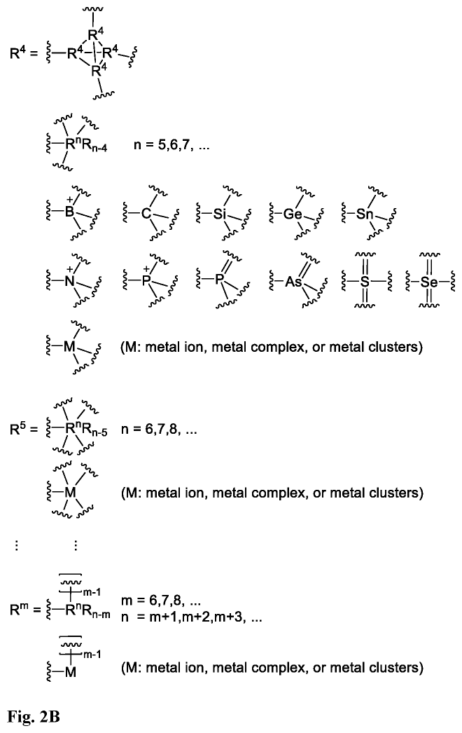

The invention encompasses all possible fragments, defined as iterative substitutions of the R^{m} groups in FIG. 2.

In each instance, any Rⁿ present in the formula of fragment R^{m} are substituted to one of the fragments of Rn defined above. This process is iterated until no R^{m} is present in the structural formula. In some variations, special iterations are executed such as empty R for ring closure, or empty R² for representation of direct linking of linkages. In some variations, counterions are left out for clearance of representation, but are considered as part of the covalent organic framework material. In some variations, metal compounds are present in the fragments, represented uniformly as M for metal ions, metal complexes (some ligands are only coordinatively bonded to the metal), and metal clusters.

Some examples of organic building units are provided in FIG. 3.

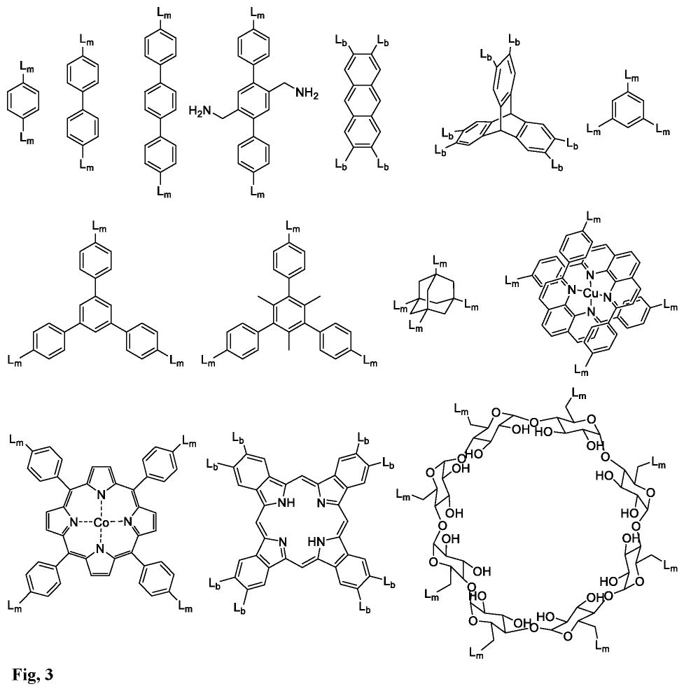

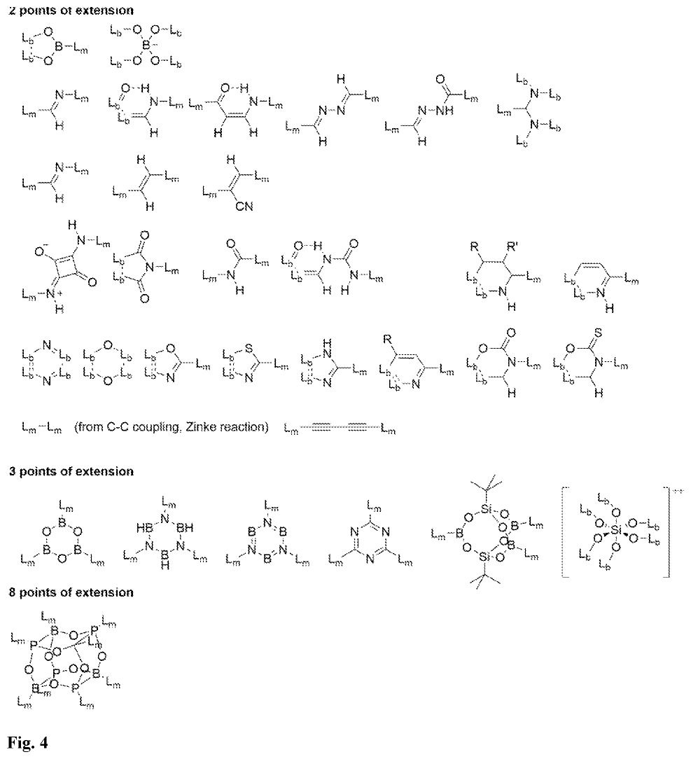

The linkages are defined, but not limited to, those specified in FIG. 4.

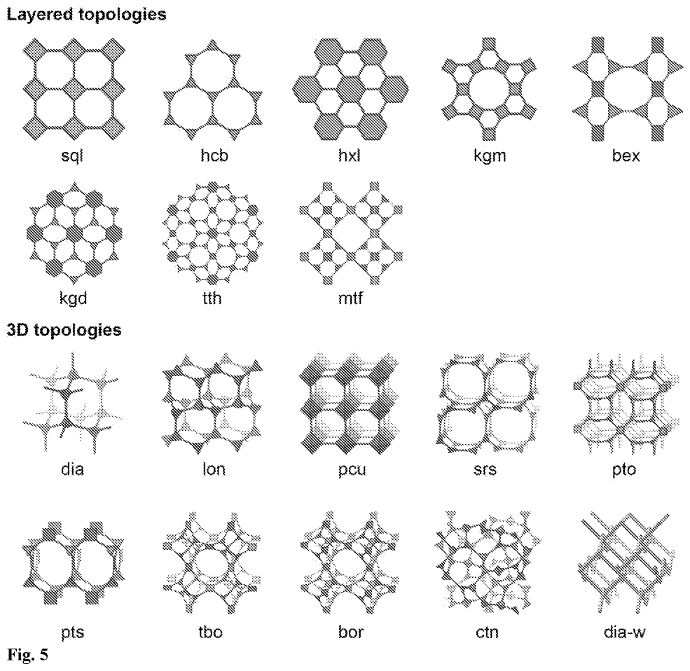

The topology in this definition is the mathematical description of the infinite extension of the structure in 1D, 2D and 3D space as open frameworks through covalent bonding between organic building units and linkages. The full definition and description of framework topology is supplied in the Reticular Chemistry Structure Resource (RCSR) database, and the topologies are denoted by net symbols. FIG. 5 provides schematic representations of common examples of topologies in COFs, i.e. sql, hcb, hxl, kgm, kgd, bex, tth, mtf, srs, dia, lon, bor, ctn, pts, tbo, pto, pcu. The topologies of the COFs in this definition are not limited to the range of FIG. 5.

In some variations, the COF contains interpenetrated structures where there exist more than one fold of framework that intercatenate or interlace with other folds of the framework that have the same connectivity. In some variations the COF is comprised of such interpenetration of frameworks but not all folds have the same connectivity.

In some variations, the COFs crystallize in topologies that are derivatives of simple nets. In some of such cases, two (or more) linkers of the same connectivity alternatively occur at equivalent nodes of the topology, described as binary (or trinary, etc.) structures. In some variations, nodes in topologies are replaced with entangled threads, and the building units are therefore closed rings (interlocking structures) or infinitive threads (weaving structures).

In some variations, the COF contains only one kind of building units or linkage at the equivalent positions of nodes or edges in the topology. In other variations, the COF contains more than one kind of building units or linkage at the equivalent positions of nodes or edges in the topology in the same bulk material, but without apparent periodicity. Such COFs are still described with the same topology but termed as multivariate COFs.

In sum, the COFs used in this description are porous, crystalline materials that are comprised within the range of the above-described building blocks, linked through the above-described covalent linkages, and extended with the connectivity of the above-described topologies. Further criteria are described in following sections and define the range of claim of COFs used in this disclosure.

In a specific embodiment, the COF used in this description is COF-609, which is composed of 2,4,6-tris(4-formylphenyl)-1,3,5-triazine and 4,4′-diaminobenzanilide linked through tetrahydroquinoline (THQ) linkage to form an all-covalent backbone with hcb topology, while the side chains from the THQ linkage bears primary, secondary, and tertiary amines that are used as the chemisorbent or part of the sorbent for CO₂ capture.

Characterization of the Defined COFs for Carbon Capture in this Disclosure

In variations, one or the combination of more than one of the techniques including powder X-ray diffraction (PXRD), single-crystal X-ray diffraction (SXRD), wide-angle X-ray scattering (WAXS), small-angle X-ray scattering (SAXS), neutron scattering, electron diffraction (ED), high-resolution transmission electron microscopy (HRTEM), scanning transmission electron microscopy (STEM), high-resolution scanning electron microscopy (HRSEM), and their technical variations such as grazing-incidence wide-angle X-ray scattering (GIWAXS), is used for confirming the crystallinity, i.e. the periodic structure of the defined composition. In all variations, Bragg diffraction or long-range continuous image of repetitive units should be observed and matched with proposed structural model of the COF.

In variations, one or the combination of more than one of the techniques including Fourier transform infrared spectroscopy (FT-IR) Raman spectroscopy, UV/Vis spectroscopy, photoluminescence spectroscopy, circular dichroism spectroscopy (CD), and solid-state nuclear magnetic resonance (NMR) are used for confirmation of the chemical composition of the COF. Such spectroscopic signals should indicate the presence of chemical elements, atoms, groups, or structural features. In some variations, isotope-enriched samples of the COF are used in such characterization, and the resultant COF sample should exhibit correspondent isotope effects.

In variations, one or the combination of more than one of the techniques including gas (N₂, O₂, Ar, CO₂, H₂O, other solvent vapor, etc.) sorption experiments and liquid-phase guest uptake experiments, are used to establish the permanent porosity and interior accessibility of the COF material. Isosteric heat (Qst) is derived by mathematical fitting of isothermal sorption measurement results of the target gas at different temperatures.

In a specific embodiment in this disclosure of COFs for CO₂ capture, CO₂ uptake at the operation temperature and CO₂ partial pressure should be large enough to achieve the desired capture capacity. In some variations where parallel water harvesting is performed, H₂O uptake at the operation temperature and humidity should be large enough to achieve the desired capacity.

In a specific embodiment in this disclosure of COFs for CO₂ capture with or without parallel water harvesting, thermal and chemical stability are both required for long-term usage as a solid adsorbent.

In variations, one or the combination of more than one of the techniques including thermalgravimetric analysis (TGA), TGA-GC, TGA-RGA, and TGA-MS, or other in-situ measurements are used to examine the behavior of the COF in the range of temperature of the operation condition. One or the combination of more than one of the techniques including NMR. FT-IR, GC, GC-MS, XRD, sorption experiments, etc., are used before and after the process to confirm no chemical decomposition, release of compounds (such as undesired guests from the pore), loss of crystallinity or porosity is present.

In variations, exposure of the COF to chemicals (such as CO₂, O₂, H₂O, SO₂, SO₃, NO, NO₂, base, acid, oxidants, reductants) used in the preparation, storage, transportation and working conditions, in gas, liquid, solution or solid form, is performed for short and long period to examine the chemical stability of the COF in the range of preparation and usage conditions. One or the combination of more than one of the techniques including NMR, FT-IR, GC, GC-MS, XRD, sorption experiments, etc., are used before and after the process to confirm no chemical decomposition, release of compounds (such as undesired guests from the pore), loss of crystallinity or porosity is present. In variations, CO₂ and H₂O stability are necessary for COFs for capturing CO₂ and H₂O from gas mixtures containing H₂O. In other variations where H₂O is not present in the preparation, storage, transportation and capturing processes, H₂O stability is not necessarily confirmed.

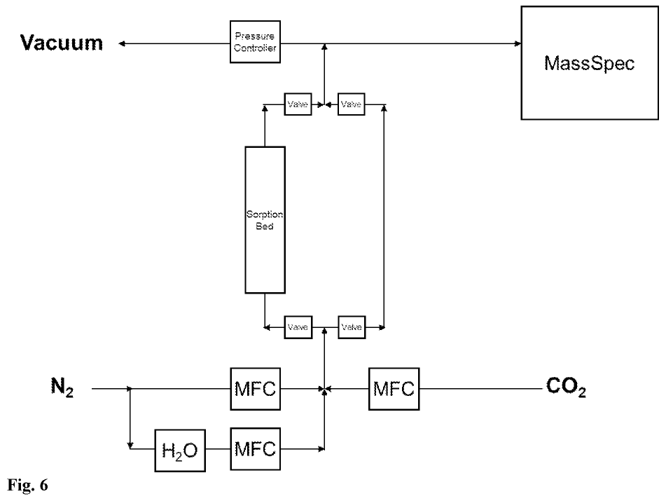

In a specific embodiment in this disclosure, the dynamic capture capacity is characterized by a breakthrough system. Minimum requirement of such systems includes the simulation of working gas composition (CO₂, H₂O, O₂, etc.), gas flow, dynamic pressure and temperature in all steps of the dynamic capture with suitable accuracy and response time for the scale of application. The system may be equipped with gas analyzing system for tracing the gases involved in the process (CO₂, H₂O, O₂, etc.) with suitable accuracy and response time for the scale of application. An example is provided in the scheme of FIG. 6. In some variations where COFs are used as active adsorbents in membranes, membrane exchangers are used to replace the sorption bed in the breakthrough system, or instead tested in other continuous flow simulation system.

### Utilization of COFs for Carbon Capture Processes

### Post-Combustion Capture (PCC)

In specific embodiments, COFs are used as solid adsorbent in the post-combustion capture of CO₂ from natural gas or coal flue gas. In most variations, the CO₂ concentration in the feed flue gas is between 4% and 16%, and the temperature of the feed flue gas is below 40° C.

In some variations, COFs are used in pure form, homogeneously mixed with other materials, or supported on other materials in the form factor of powders. In some variations, COFs are used in pure form, homogeneously mixed with other materials, or supported on other materials in the form factor of shape bodies. In these scenarios, the powder or shape bodies are used in packed bed, cartridge exchanger, fluidized bed, etc.

In these scenarios, removal of CO₂ from COFs involves heating, change of pressure, gas sweeping, washing, etc., or the combination of some or all of them.

In these scenarios, COFs exhibiting such properties are used:

High working capacity difference toward CO₂ from the combination of chemisorption (if present) and physisorption depending on the adsorption condition and regeneration condition.
For chemisorption, bearing reactive functional groups such as —NH₂, —NHR.
For physisorption, high surface area with polar functional groups such as —OH, —F.

For the dynamic capacity measurement of such COFs, breakthrough experiments are configured with feed gas mixture of 4%-16%, corresponding humidity and temperature.

Adequate affinity to CO₂ such that enough working capacity is retained in the presence of H₂O.

Robustness: chemical stability to H₂O, O₂, CO₂, and impurities in both adsorption condition and regeneration condition, including the retention of chemical composition, crystallinity, sorption capacities and porosity. Thermal stability toward the range of operation temperature.

Open framework structure with permanent porosity to ensure efficient mass transfer.

In some variations where heating is used for regeneration, low heat capacity.

In some variations where the COF is in shape body or supported by other materials, tight binding for mechanical stability.

In some variations, COFs are used in pure form, homogeneously mixed with other materials, or supported on other materials in the form factor of membranes. In these scenarios, the powder or shape bodies are used in membrane filtration, membrane exchanger, or cartridge exchanger, etc.

High, selective affinity toward CO₂ that increases the solubility of the membrane, through both chemisorption (if present) and physisorption at the separation condition.
For chemisorption, reactive functional groups such as —NH₂, —NHR, —CH₂OH are part of the COF.
For physisorption, polar functional groups such as —OH, —F, are part of the COF.

For the dynamic capacity measurement of such COFs, breakthrough experiments or membrane-specific continuous tests are configured with feed gas mixture of 4%-16%, corresponding humidity and temperature.

Adequate affinity to CO₂ such that enough working capacity is retained in the presence of H₂O.

Robustness: chemical stability to H₂O, O₂, CO₂, and impurities in both adsorption condition and regeneration condition, including the retention of chemical composition, crystallinity, sorption capacities and porosity. Thermal stability toward the range of operation temperature.

In some variations where the COF is supported by other materials in the membrane, tight binding with the support for mechanical stability.

In some variations where heating is used for regeneration, low heat capacity.

### Direct Air Capture (DAC)

In a specific embodiment, COFs are used as solid adsorbent in the direct capture of CO₂ from ambient air. In most variations, the CO₂ concentration in the feed flue gas is atmospheric concentration (˜400 ppm, 1 atm. In some variations, CO₂ concentration >400 ppm when compressed air is used) or slightly higher through compression or in a closed, non-ambient chamber, and the temperature of the feed gas is ambient temperature.

In some variations, COFs are used in pure form, homogeneously mixed with other materials, or supported on other materials in the form factor of powders. In some variations, COFs are used in pure form, homogeneously mixed with other materials, or supported on other materials in the form factor of shape bodies. In these scenarios, the powder or shape bodies are used in packed bed, cartridge exchanger, fluidized bed, etc.

In these scenarios, removal of CO₂ from COFs involves heating, change of pressure, gas sweeping, washing, etc., or the combination of some or all of them.

In these scenarios, COFs exhibiting such properties are used:

High working capacity difference toward CO₂ from chemisorption depending on the adsorption condition and regeneration condition.
For chemisorption, high gravimetric or volumetric density of reactive functional groups such as —NH₂, —NHR, —CH₂OH.
For physisorption, high surface area with polar functional groups such as —OH, —F, to enhance the affinity to CO₂.

For the dynamic capacity measurement of such COFs, breakthrough experiments are configured with feed gas mixture of ˜400 ppm, corresponding humidity and temperature.

Adequate affinity to CO₂ such that enough working capacity is retained in the presence of H₂O.

Robustness: chemical stability to H₂O, O₂, CO₂, and impurities in both adsorption condition and regeneration condition, including the retention of chemical composition, crystallinity, sorption capacities and porosity. Thermal stability toward the range of operation temperature.

Open framework structure with permanent porosity to ensure efficient mass transfer.

In some variations where heating is used for regeneration, low heat capacity.

In some variations where the COF is in shape body or supported by other materials, tight binding for mechanical stability.

### Parallel Water Harvesting

In some variations, the COF adsorbent exhibit high uptake of both CO₂ and H₂O at the same time of PCC or DAC. The CO₂ and H₂O can be therefore removed in the same step, or in different steps through different conditions. Through facile further purification, such COF adsorbent can produce high-purity water as a side-product of CO₂ capture from air or from flue gas.

In these scenarios, COFs exhibiting such properties are used:

High working capacity difference toward H₂O from physisorption depending on the adsorption condition and regeneration condition.

For the dynamic capacity measurement of such COFs, breakthrough experiments are configured with feed gas mixture at the desired humidity and temperature.

Adequate affinity to H₂O such that enough working capacity is retained in the presence of CO₂.

Robustness: chemical stability to H₂O, O₂, CO₂, and impurities in both adsorption condition and regeneration condition, including the retention of chemical composition, crystallinity, sorption capacities and porosity. Thermal stability toward the range of operation temperature.

Open framework structure with permanent porosity to ensure efficient mass transfer.

In some variations where heating is used for regeneration, low heat capacity.

In some variations where the COF is in shape body or supported by other materials, tight binding for mechanical stability.

### Examples: COF-609

COF-609 is an example of COF sorbent materials for showcasing CO₂ capturing capacity exhibited in COF materials, which is capable of capturing CO₂ from various concentrations in the presence of water and oxygen.

COF-609 is synthetically accessed through a three-step synthesis involving crystallization of a porous imine COF, and post-synthetically functionalizes the COF backbone through cycloaddition and subsequent nucleophilic substitution.

In the first step, synthesis of COF-609-Im was performed in a borosilicate glass tube measuring 8 mm×10 mm (i.d.×o.d.), where 2,4,6-tris(4-formylphenyl)-1,3,5-triazine (TFPT, 15.7 mg, 0.04 mmol) and 4,4′-diaminobenzanilide (DABA, 13.6 mg, 0.06 mmol) are mixed in 0.85 mL mesitylene and 0.15 mL n-butanol. The mixture was sonicated for 5 minutes before introducing 0.04 mL acetic acid solution (9 mol L⁻¹ in water). The obtained suspension was further sonicated for 5 minutes and was flash frozen at 77 K in a liquid nitrogen bath, evacuated to an internal pressure below 150 mTorr, and flame sealed. The length of the tube was reduced to around 10 cm upon sealing. After warming to room temperature, the reaction was heated at 140° C. for 4 days to yield a yellow solid. The solid was collected, washed with acetone and methanol for 1 day in a Soxhlet extractor, dried with supercritical CO₂, and degassed at 140° C. for 24 h to yield COF-609-Im as a yellow-colored solid. Elemental analysis for C₂₉H₁₉N₅O: Calcd. C, 76.81%, H, 4.22%, N, 15.44%; Found C, 76.36%, H, 4.61%, N, 15.34%.

In the second step, conversion of the imine linkage in COF-609-Im was performed by mixing COF-609-Im (136.2 mg, 0.6 mmol by imine linkage), anhydrous FeCl₃ (12 mg, 0.072 mmol), as well as 2-chloroethyl vinyl ether (0.90 mL, 8.8 mmol) in diethyl ether (12 mL) under an inert atmosphere, in a 20 mL glass vial equipped with an open-top screw cap with a PTFE/silicone septum. The vial was kept still at 50° C. for 2 days. After cooling to room temperature, the supernatant was decanted and the solid was washed with methanol and acetone in a Soxhlet extractor for 1 day. The solid was collected, washed with acetone and methanol for 1 day in a Soxhlet extractor, dried with supercritical CO₂, and degassed at 140° C. for 24 h to yield COF-609-THQ/Im as a dark-yellow solid (187.8 mg). Elemental analysis for C₃₇H₃₃N₅O₃Cl₂: Calcd. C, 66.67%, H, 4.99%, N, 10.51%; Found C, 66.98%, H, 5.01%, N, 10.27%.

In the last step, activated powders of COF-609-THQ/Im (131 mg) were immersed in 2.0 mL tris(3-aminopropyl)amine (TRPN) under argon in a 4 mL glass vial sealed by an open-top screw cap with a PTFE/silicone septum. The reaction was heated to 140° C. for 24 h before cooling down to room temperature, and washed repetitively with methanol, acetone, and dichloromethane for 1 day. The sample was further treated with a 10 wt % potassium hydroxide solution in methanol for 1 day, and washed repetitively with methanol and acetone for 1 day before activation under a dynamic vacuum at 140° C. for 24 h. The product was obtained as brown powders for characterization and performance tests.

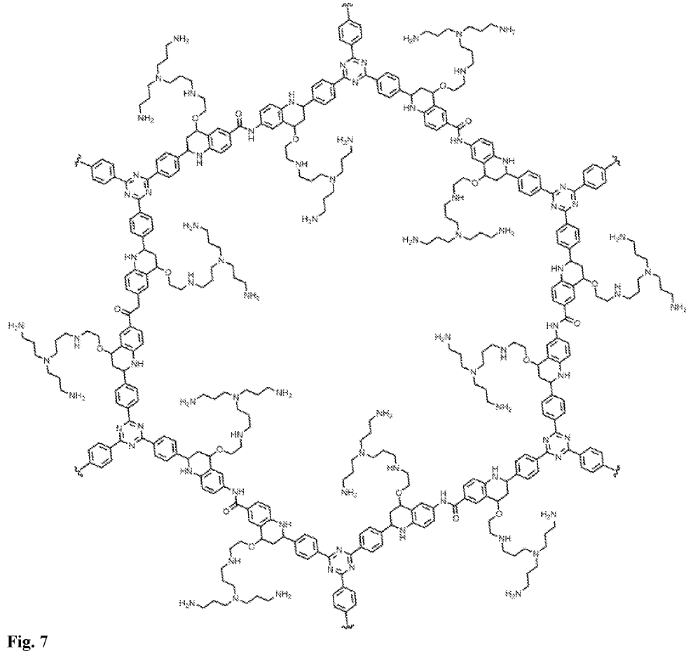

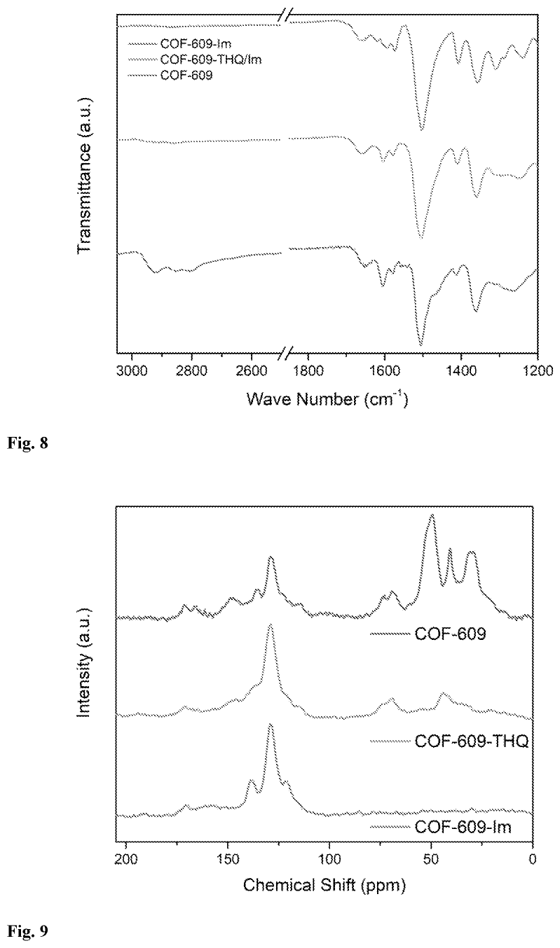

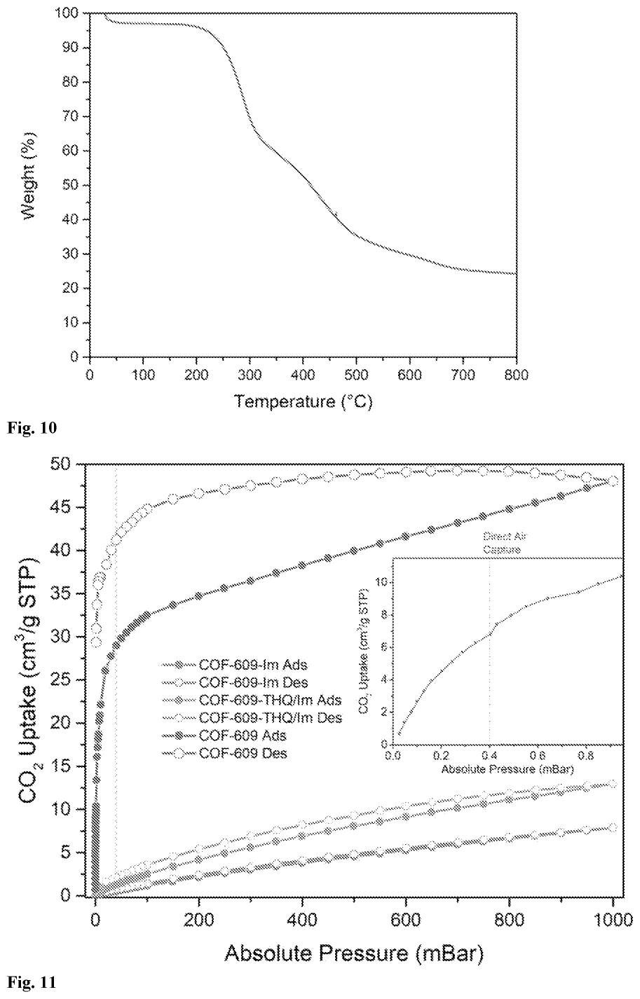

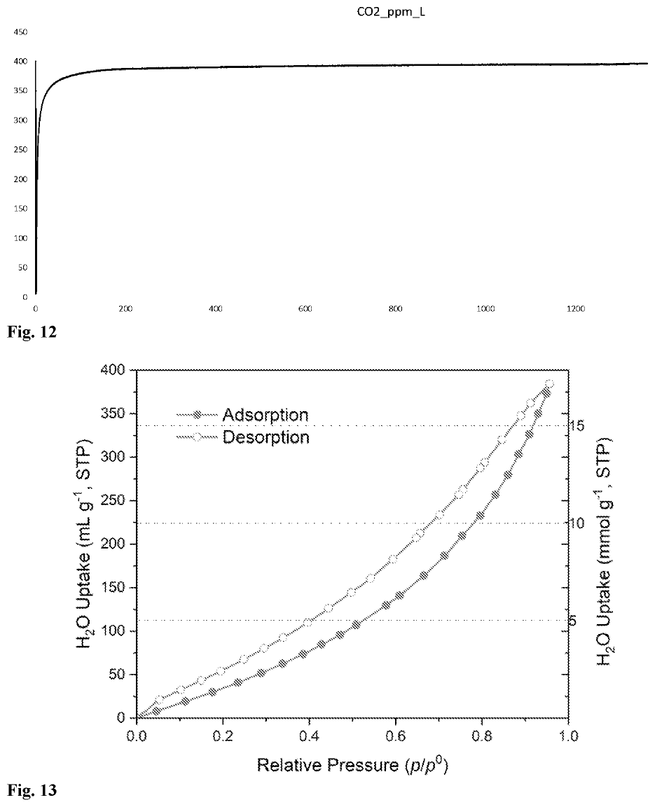

This chemistry and the composition of the product were evidenced by Fourier Transform Infrared Spectroscopy (FT-IR, see FIG. 8) and solid-state nuclear magnetic resonance (ssNMR, see FIG. 9) spectroscopy. COF-609 exhibits sufficient thermal stability where no weight loss was observed in thermogravimetric analysis of COF-609 up to >200° C. (FIG. 10). As a derivative of COF-609-Im, COF-609 comprises of extended layer backbones with honeycomb shaped pores, to which alkyl amines are covalently bonded and point into the interior of the pores. This exposes highly nucleophilic functional groups to the accessible surface of the sorbent, which reacts with CO₂ even from a low concentration (such as ˜400 ppm in air), and release in a reversible manner. This is proved by the CO₂ sorption isotherm measured between 0 and 1000 mbar (FIG. 11), where COF-609 exhibits exceptionally higher uptake of CO₂ under all pressures of CO₂ within the measurement range. The measured sample of COF-609 displays an uptake capacity of CO₂ is 0.304 mmol/g at 0.4 mbar (400 ppm at 1 bar, corresponding to direct air capture), 1.292 mmol/g at 40 mbar (4% at 1 bar, corresponding to methane flue gas), and 1.502 mmol/g at 150 mbar (15% at 1 bar, corresponding to coal flue gas). In the presence of humidity (25° C., 1 bar, relative humidity 50%), the uptake capacity of the measured COF-609 was determined as 0.393 mmol/g at 0.4 mbar (400 ppm at 1 bar, corresponding to direct air capture, FIG. 12), while water uptake is comparably low as evidenced by H₂O vapor sorption isotherm measurements at 25° C. (FIG. 13).

Shown in the graph is the downstream concentration of CO₂ as a function of elapsed time. The measurement was conducted at 25° C. in a constant flow of 50 mL/min 400 ppm CO₂ balanced in air (N₂, O₂) at 1 bar and 50% relative humidity. Numerical integration was performed where compensation for temperature and instrument dead space were considered for the determination of the sample's uptake.

1.-12. (canceled)

13. A composition comprising a covalent organic framework (COF) material, wherein the COF comprises 2,4,6-tris(4-formylphenyl)-1,3,5-triazine and 4,4′-diaminobenzanilide linked through a tetrahydroquinoline (THQ) linkage to form an extended layer backbone with honeycomb shaped pores, to which alkyl amines are covalently bonded and point into the interior of the pores.

14. The composition of claim 13, contained in a matrix configured as a sorption bed, fluidized bed, coated heat exchanger, or membrane.

15. The composition of claim 13, contained in a matrix configured as a sorption bed, fluidized bed, coated heat exchanger, or membrane, in a fluid flow path configured to pass the air or mixture over, around and/or through the matrix.

16. The composition of claim 13, comprising an air or post-combustion exhaust gas mixture, wherein water is present in the air or mixture, and the material is configured and is operative to harvest the water from the air or mixture.

17. A system for capturing carbon dioxide from air or a post-combustion exhaust gas mixture comprising a matrix containing the composition of claim 13, configured as a solid adsorbent for capturing the carbon dioxide from the air or mixture.

18. The system of claim 17, wherein the matrix is configured as a sorption bed.

19. A method comprising using the composition of claim 13, as a solid adsorbent for capturing carbon dioxide from air or a post-combustion exhaust gas mixture.

20. A composition comprising a covalent organic framework (COF) material, wherein the COF comprises 2,4,6-tris(4-formylphenyl)-1,3,5-triazine and 4,4′-diaminobenzanilide linked through a tetrahydroquinoline (THQ) linkage to form an all-covalent backbone with hcb topology, wherein side chains from the THQ linkage bear primary, secondary, and tertiary amines operable as chemisorbents for CO₂ capture.

21. The composition of claim 20, contained in a matrix configured as a sorption bed, fluidized bed, coated heat exchanger, or membrane.

22. The composition of claim 20, contained in a matrix configured as a sorption bed, fluidized bed, coated heat exchanger, or membrane, in a fluid flow path configured to pass the air or mixture over, around and/or through the matrix.

23. The composition of claim 20, comprising an air or post-combustion exhaust gas mixture, wherein water is present in the air or mixture, and the material is configured and is operative to harvest the water from the air or mixture.

24. A system for capturing carbon dioxide from air or a post-combustion exhaust gas mixture comprising a matrix containing the composition of claim 20, configured as a solid adsorbent for capturing the carbon dioxide from the air or mixture.

25. The system of claim 23, wherein the matrix is configured as a sorption bed.

26. A method comprising using the composition of claim 20, as a solid adsorbent for capturing carbon dioxide from air or a post-combustion exhaust gas mixture.

27. A composition comprising a covalent organic framework (COF) material comprising the following structure:

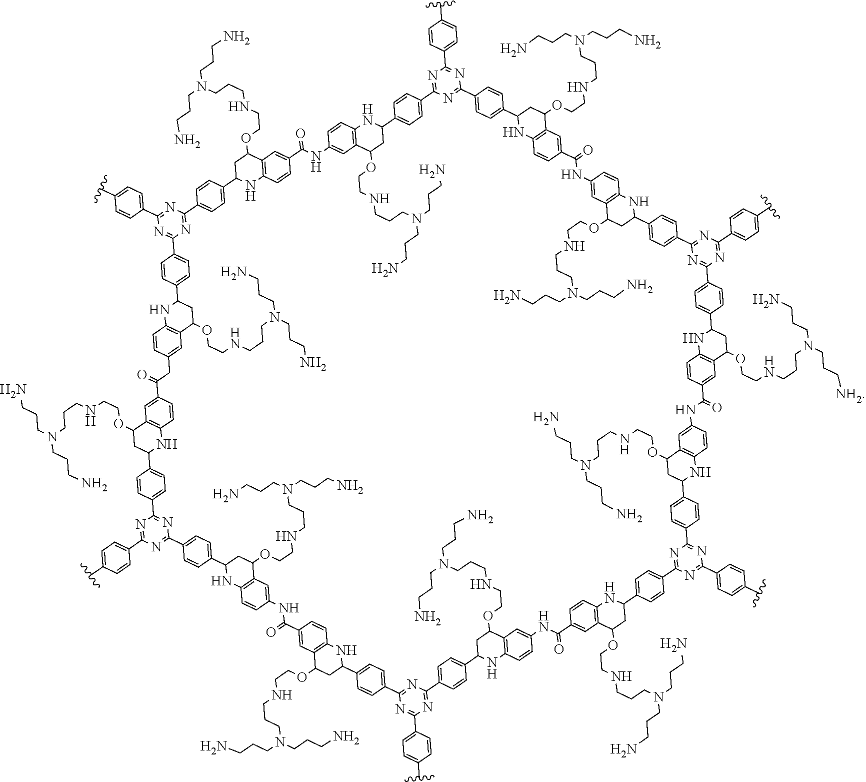

28. The composition of claim 27, contained in a matrix configured as a sorption bed, fluidized bed, coated heat exchanger, or membrane.

29. The composition of claim 27, contained in a matrix configured as a sorption bed, fluidized bed, coated heat exchanger, or membrane, in a fluid flow path configured to pass the air or mixture over, around and/or through the matrix.

30. The composition of claim 27, comprising an air or post-combustion exhaust gas mixture, wherein water is present in the air or mixture, and the material is configured and is operative to harvest the water from the air or mixture.

31. A system for capturing carbon dioxide from air or a post-combustion exhaust gas mixture comprising a matrix containing the composition of claim 27, configured as a solid adsorbent for capturing the carbon dioxide from the air or mixture.

32. The system of claim 31, wherein the matrix is configured as a sorption bed.

33. A method comprising using the composition of claim 27, as a solid adsorbent for capturing carbon dioxide from air or a post-combustion exhaust gas mixture.
